(19) United States
(12) Patent Application Publication
(10) Pub. No.: US 2024/0046147 A1
(43) Pub. Date: Feb. 8, 2024

(54) SYSTEMS AND METHODS FOR ADMINISTRATING A FEDERATED LEARNING NETWORK

(71) Applicants: OWKIN, INC., New York, NY (US); OWKIN FRANCE SAS, Paris (FR)

(72) Inventors: Mathieu GALTIER, Paris (FR); Mathieu ANDREUX, Paris (FR); Camille MARINI, Paris (FR); Eric TRAMEL, Le Kremlin Bicetre (FR); Inal DJAFAR, Paris (FR); Jean DU TERRAIL, Paris (FR)

(21) Appl. No.: 18/254,693

(22) PCT Filed: Dec. 1, 2021
(86) PCT No.: PCT/US2021/061417

§ 371 Date: May 26, 2023

(30) Foreign Application Priority Data
Dec. 1, 2020 (EP) 20306478.7

(51) Int. Cl. G06N 20/00

(52) U.S. Cl. CPC G06N 20/00

(57) ABSTRACT

A method and apparatus of a device that trains or evaluates a model is described. In an exemplary embodiment, the device creates a loop network between a central aggregating node and a set of one or more worker nodes, where the loop network communicatively couples the central aggregating node. The device further receives and broadcasts a model training or evaluation request from one of the nodes in the loop network to one or more other nodes in the loop network.

### CROSS REFERENCE

This application claims the benefit of European Application No. 20306478.7 filed Dec. 1, 2020, and the entire content is hereby incorporated by reference.

### FIELD OF INVENTION

This invention relates generally to machine learning and more particularly to administrating a federated machine learning network.

### BACKGROUND OF THE INVENTION

Machine Learning (ML) is a promising field with many applications; organizations of all sizes are practicing ML, from individual researchers to the largest companies in the world. In doing so, ML processes consume an extremely large amount of data. Indeed, ML models require large amounts of data to learn from examples efficiently. In ML, more data often leads to better predictive performance, which measures the quality of an ML model. Usually, different sources, such as users, patients, measuring devices, etc., produce data in a decentralized way. This source distribution makes it difficult for a single source to have enough data for training accurate models. Currently, the standard methodology for ML is to gather data in a central database. However, these practices raise important ethical questions which ultimately could limit the potential social benefits of ML.

However, data used for training models can be sensitive. In the case of personal data, which are explicitly related to an individual, the privacy of individuals is at stake. Personal data is particularly useful and valuable in the modern economy. With personal data it is possible to personalize services, which has brought much added value to certain applications. This can involve significant risks if the data are not used in the interest of the individual. Not only should personal data be secured from potential attackers, but their use by the organization collecting them should also be transparent and aligned with user expectations. Beyond privacy, data can also be sensitive when it has economic value. Information is often confidential and data owners want to control who accesses it. Examples range from classified information and industrial secret to strategic data which can give an edge in a competitive market. From the perspective of tooling, preserving privacy and preserving confidentiality can be similar and both differ mostly in the lack of regulation covering the latter.

Thus, there is a tradeoff between predictive performance improvement versus data privacy and confidentiality. ML always needs more data, but data tends to be increasingly more protected. The centralization paradigm where a single actor gathers all data on its infrastructure is reaching its limit.

A relevant way to solve this tradeoff lies in distributing computing and remote execution of ML tasks. In this approach, the data themselves never leave their nodes. In ML, this includes Federated learning: each dataset is stored on a node in a network, and only the algorithms and predictive models are exchanged between them. This immediately raises the question of the potential information leaks in these exchanged quantities, including a trained model. The research on ML security and privacy has seen a significant increase in recent years covering topics from model inversion and membership attacks to model extraction. A residual risk is that data controllers still have to trust a central service orchestrating federated learning, and distributing models and metadata across the network.

### SUMMARY OF THE DESCRIPTION

A method and apparatus of a device that trains a model is described. In an exemplary embodiment, the device creates a loop network between a central aggregating node and a set of one or more worker nodes, where the loop network communicatively couples the central aggregating node and the set of one or more worker nodes. The device further receives and broadcasts a model training request from one of the nodes in the loop network to one or more other nodes in the loop network.

In a further embodiment, a device that evaluates a model is described. In one embodiment, the device creates a loop network between a central aggregating node and a set of one or more worker nodes, where the loop network communicatively couples the central aggregating node and the set of one or more worker nodes. In addition, the device receives and broadcasts a model evaluation request for the model from the central aggregating node to one or more worker nodes.

Other methods and apparatuses are also described.

### BRIEF DESCRIPTION OF THE DRAWINGS

The present invention is illustrated by way of example and not limitation in the figures of the accompanying drawings in which like references indicate similar elements.

FIG. 1 is a block diagram of one embodiment of a system for training a machine learning model.

FIG. 2 is a block diagram of one embodiment of a system that administers different federated learning network loops for training machine learning models.

FIG. 3 is a flow diagram of one embodiment of a process to administer different federated learning network loops.

FIG. 4 is a flow diagram of one embodiment of a process to create a federated learning network loop.

FIG. 5 is a flow diagram of one embodiment of a process to monitor existing federated learning network loops.

FIG. 6 is a flow diagram of one embodiment of a process to update loop nodes.

FIG. 7 is a flow diagram of one embodiment of a process to communicate information to loop nodes.

FIG. 8 is a flow diagram of one embodiment of a process to aggregate parts of a trained model into a trained model.

FIG. 9 illustrates one example of a typical computer system, which may be used in conjunction with the embodiments described herein.

### DETAILED DESCRIPTION

A method and apparatus of a device that creates a loop network for training a model is described. In the following description, numerous specific details are set forth to provide thorough explanation of embodiments of the present invention. It will be apparent, however, to one skilled in the art, that embodiments of the present invention may be practiced without these specific details. In other instances, well-known components, structures, and techniques have not been shown in detail in order not to obscure the understanding of this description.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

The processes depicted in the figures that follow, are performed by processing logic that comprises hardware (e.g., circuitry, dedicated logic, etc.), software (such as is run on a general-purpose computer system or a dedicated machine), or a combination of both. Although the processes are described below in terms of some sequential operations, it should be appreciated that some of the operations described may be performed in different order. Moreover, some operations may be performed in parallel rather than sequentially.

The terms “server,” “client,” and “device” are intended to refer generally to data processing systems rather than specifically to a particular form factor for the server, client, and/or device.

A method and apparatus of a device that creates a loop network for training a model is described. In one embodiment, the device acts as a master node that couples to a set of central aggregators and a set of worker nodes over a master node network. In one embodiment, the master node allows for the set of central aggregators and a set of worker nodes to communicate with the master node for the purposes of orchestrating loop networks, but the worker nodes are not visible with the central aggregators via the master node networks. For example and in one embodiment, the Internet Addresses (IP) of the worker's node are kept private from central aggregators, so that the central aggregators cannot contact the worker nodes via the master node network. In one embodiment, the central aggregator manages the training of an untrained machine learning model using one or more worker nodes. Each worker node includes a training data set and can use an algorithm and training plan furnished by the central aggregator.

The issue is connecting the worker nodes with the central aggregator. Because the training data can be quite valuable, each worker node will wish to maintain the privacy of this data. Thus, the worker nodes do not want to needlessly be exposed on a network, which causes an issue for a central aggregator that wants to make use of the worker node. The device, or master node, can match worker nodes with a central aggregator by receiving requests from the central aggregators to train a model and match these requests with the availability of various worker nodes. In one embodiment, the master node can post the central aggregator request, where each interested worker node can request to be part of training for the central aggregator. With the requests from the worker nodes, the master node creates a loop network that includes the central aggregator and the relevant worker nodes, so that the central aggregator can start and manage the training of the machine learning model. In one embodiment, the central aggregator can send the algorithm and the model (along with other data) to each of the worker nodes, so the workers do not expose their training data for training of the machine learning model.

In addition to creating the loop networks, the master node can monitor the loop network, update the software on the central aggregator and the worker nodes, and can communicate information from one node to another node.

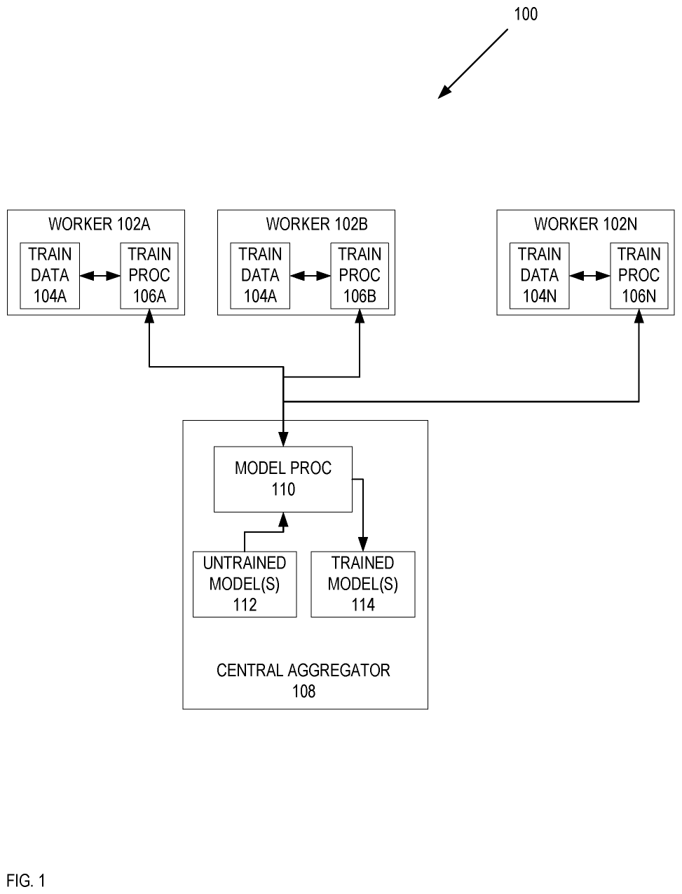

FIG. 1 is a block diagram of one embodiment of a system 100 for training a machine learning model. In FIG. 1, the system 100 includes a central aggregator 108 coupled to multiple worker nodes 102A-N, where the system 100 trains the machine learning model. In one embodiment, each of the central aggregator 108 and worker nodes 102A-N is one of a personal computer, laptop, server, mobile device (e.g., smartphone, laptop, personal digital assistant, music playing device, gaming device, etc.), and/or any device capable processing data. In addition, each of the central aggregator 108 and worker nodes 102A-N can be either a virtual or a physical device. In one embodiment, a machine learning model (or simply a model) is a potentially large file containing the parameters of a trained model. In the case of a neural network, a model would contain the weights of the connections. A trained model is the result of training a model with a given set of training data. In one embodiment, the central aggregator 108 manages the training of the untrained model 112. In this embodiment, the central aggregator 108 has the untrained model 112 and sends some or all of the untrained model 112 and a training plan to each of the workers 102A-N. In one embodiment, the training plan includes a configuration for how the training is to be conducted. In this embodiment, the training plan can include the algorithm. In this embodiment, the training plan can include an object that defines the purpose of the computations. For example and in one embodiment, the objective specifies a data format that the training data, an algorithm, and/or model should use, an identity of the test data points used to compare and evaluate the models and, metric calculation data which is used to quantify the accuracy of a model. The training plan can also include an algorithm, which is a script that specifies the method to train a model using the training data. In particular, the algorithm specifies the model type and architecture, the loss function, the optimizer, hyperparameters and, also identifies the parameters that are tuned during training.

In one embodiment, each of the workers 102A-N receives the untrained model 112 and performs an algorithm to train the model 112. For example and in one embodiment, a worker 102A-N includes a training data 104A-N and a training process 106A-N that is used to train the model, training a machine learning model can be done in a variety of ways. In one embodiment, an untrained machine learning model includes initial weights, which are used to predict a set of output data. Using this output data, an optimization step is performed and the weights are updated. This process happens iteratively until a predefined stopping criterion is met. With a trained model computed by the worker 102A-N, the worker 102A-N sends the trained model 114 back to the central aggregator 108. The central aggregator 108 receives the different trained models from the different workers 102A-N and aggregates the different trained models into a single trained model. While in one embodiment the central aggregator 108 outputs this model as final trained model 114 that can be used for predictive calculations, in another embodiment, depending on the quality of the resulting model as well as other predefined criteria, the central aggregator 108 can send back this model to the different workers 102A-N to repeat the above steps.

In one embodiment, the system 100 works because the central aggregator 108 knows about and controls each of the worker nodes 102A-N because the central aggregator 108 and workers 102A-N are part of the same organization. For example and in one embodiment, the central aggregator 108 can be part of a company that produces an operating system for mobile devices and each of the worker nodes 102A-N are those mobile devices. Thus, the central aggregator 108 knows what training data each of the workers (or at least the type of training data that each worker 102A-N has). However, this type of system does not preserve the privacy of the data stored on the worker nodes 102A-N.

A different type of model training scenario can be envisioned where the central aggregator does not know the type of training data each worker node has, or possibly even the existence of a worker node. In one embodiment, an entity with a worker node may not want to expose the worker node (and its training data) to the central aggregator or to another device in general. However, that worker node is available to train a model. What is needed is a coordinating device or service that matches requested model training work from a central aggregator with available worker nodes while preserving data privacy for each worker node. As per above, the training data can be quite valuable from an economic or privacy sense. In one embodiment, a federated learning network is designed that includes a master node that is used to administer a loop network of a set of one or more worker nodes and a central aggregator. In this embodiment, the loop network is a network formed by the set of one or more worker nodes and a central aggregator for the purpose of training a model requested by the central aggregator. The master node administers this network by determining who can participate in the network (e.g., checking prerequisites and adding or removing partners for this network). In addition, the master node monitors the network traffic and operations of the loop network, maintains and updates the software of worker and central aggregator, and/or communicates information to the worker and central aggregator.

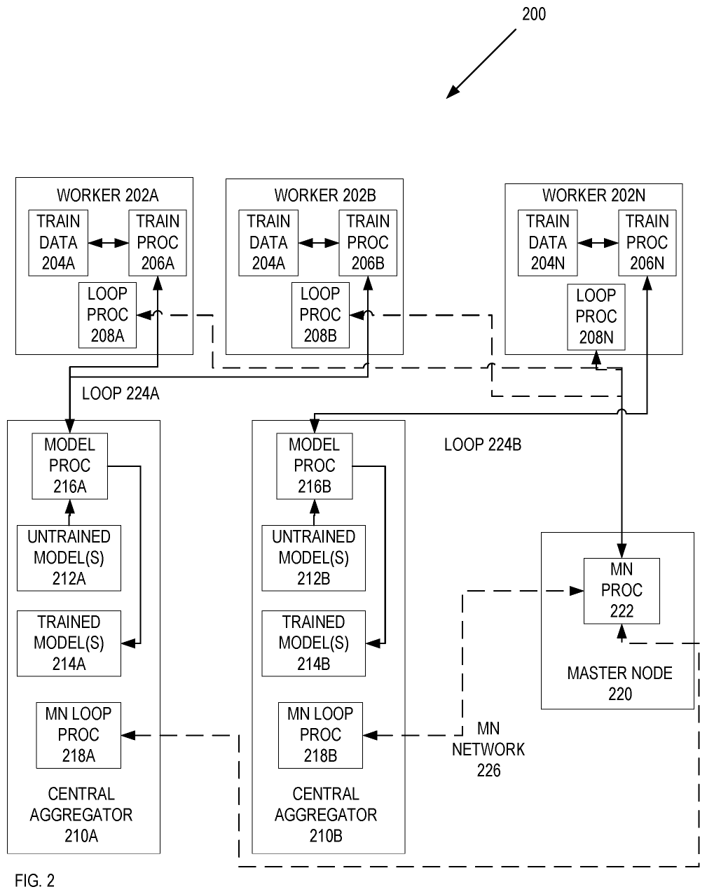

FIG. 2 is a block diagram of one embodiment of a system 200 that administers different federated learning network loops for training machine learning models. In FIG. 2, the system 200 includes a master node 220, central aggregators 210A-B, and worker nodes 202A-N that are coupled via a master node network 226. The master node network 226 allows the master node to communicate with each of the worker nodes 202A-N and/or the central aggregators 210A-B. The master node network 226, however, does not allow the central aggregators 210A-B to directly communicate with the worker nodes 202A-N. This allows the worker nodes 202A-N to remain private and helps protect the data stored by each of the worker nodes 202A-N. In one embodiment, each of the master node 220, central aggregator 210A-B, worker nodes 202A-N is one of a personal computer, laptop, server, mobile device (e.g., smartphone, laptop, personal digital assistant, music playing device, gaming device, etc.), and/or any device capable processing data. In addition, each of the master node 220, central aggregator 210A-B, worker nodes 202A-N can be either a virtual or a physical device.

In one embodiment, each of the worker nodes 202A-N includes training data 204A-N, training process 206A-N, and loop process 208A-N. In this embodiment, each the training data 204A-N is a separate set of data that can be used to train a model (e.g., such as the training data 104A-N as illustrated in FIG. 1 above). The training process 206A-N is a process that is used to train the model, such as the training processes 106A-N described in FIG. 1 above. In addition, each of the worker nodes 202A-N includes a loop process 208A-N, respectively, that communicates with the master node 220, where the loop process 208A-N configures the corresponding worker node 202A-N using configuration information supplied by the master node 220. In addition, the loop process 208A-N responds to queries for information from the master node 220.

In one embodiment, each of the central aggregators 210A-B includes untrained models 212A-B, which are models that are waiting to be trained using the training data of the worker node 202A-N. Once these models are trained, the central aggregators 210A-B stores the trained models 214-B and can be used for predictive calculations. In addition, each of the central aggregators 210A-B includes a master node loop process 218A-B which is a process that communicates with the master node 220, where the master node loop process 218A-B configures the corresponding central aggregator 210A-B using configuration information supplied by the master node 220. In addition, the master node loop process 218A-B responds to queries for information from the master node 220. While in one embodiment, there are two central aggregators and one master node illustrated, in alternate embodiment, there can be more or less numbers of either the central aggregators and/or the master node.

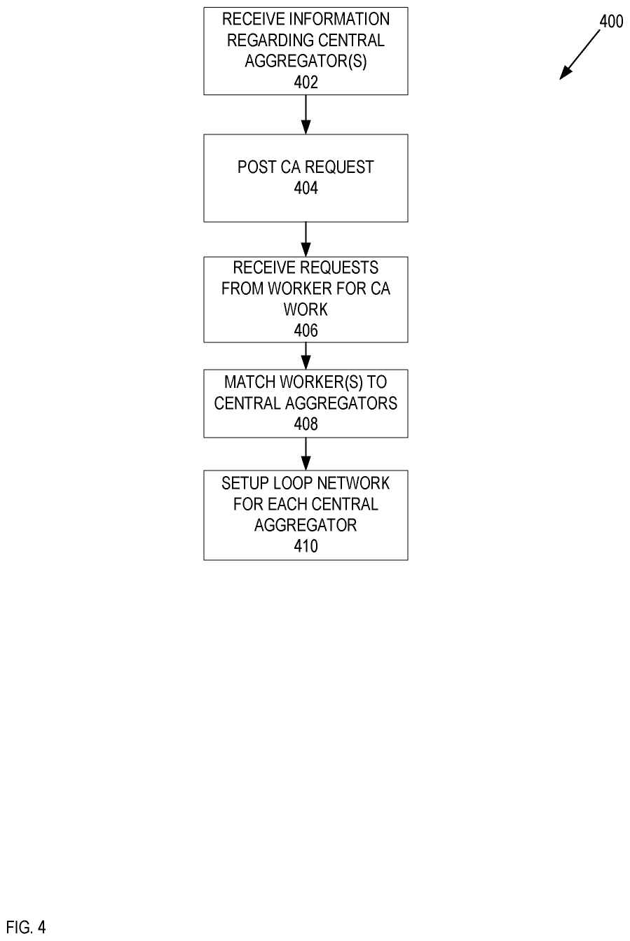

The master node 220, in one embodiment, administers the creation of one or more loop networks 224A-B, where each of the loop networks are used to communicatively couple one of the central aggregators 210A-B with a set of one or more worker nodes 202A-N. For example and in one embodiment, in FIG. 2, two different loop networks 224A-B are illustrated. Loop network 224A includes worker nodes 202A-B and central aggregator 210A and loop network 224A includes worker node 202N and central aggregator 210B. In one embodiment, the master node 220 creates these networks by providing a mechanism for central aggregators 210A-B to post requests for model training work (e.g., providing a portal that a central aggregator 210A-B can log into and post requests for model training work). With the request posted, each of the worker nodes 202A-N can respond to the request and indicate that this worker node 202A-N will participate in the model training. The master node coordinates the creation of a loop network 224A-B by matching interested worker nodes 202A-N with requests from central aggregators. Creation of loop networks is further described in FIG. 4 below.

For example and in one embodiment, central aggregator 210A sends a request for model training work to the master node 220, where the master node 220 posts the request. Worker nodes 202A-B respond to the posted request by indicating that these nodes are willing to perform requested work. In response, the master node 220 creates loop network 224A that communicatively couples worker nodes 202A-B with central aggregator 210A. With the loop network created, the central aggregator 210A can start the model training process as described in FIG. 1 above.

As another example and embodiment, central aggregator 210B sends a request for model training work to the master node 220B, where the master node 220 posts this request. Worker node 220N responds to the posted request indicating that this node is willing to perform the requested work. In response, the master node 220 creates loop network 224B that communicatively couples worker node 202N with central aggregator 210N. With the loop network 224B created, the central aggregator 210B can start the model training process as described in FIG. 1 above. While in one embodiment, the loop networks 224A-B are illustrated with one or two worker nodes, in alternate embodiments, each of the loop networks 224A-B can include more or less numbers of worker nodes (e.g., a loop network can include tens, hundreds, thousands, or more worker nodes in the loop network).

In one embodiment, a worker node 202A-202N or central aggregator node 210A-B receives and broadcasts a model training request to other nodes on that loop network 224A-B. In this embodiment, one of the nodes of the loop network receives a model training request (e.g., from the central aggregating node of the loop network or from a user node associated with the loop network. This node then broadcasts this training request to one, some, or other nodes in the loop network. For example and in one embodiment, worker node 202B receives a model training request for a model from an external node (e.g., a user node), where this worker node 202B is part of the loop network 224A. The worker node 202B broadcasts this request to other nodes in the loop network 224A (e.g., worker node 202A and/or central aggregator 210A).

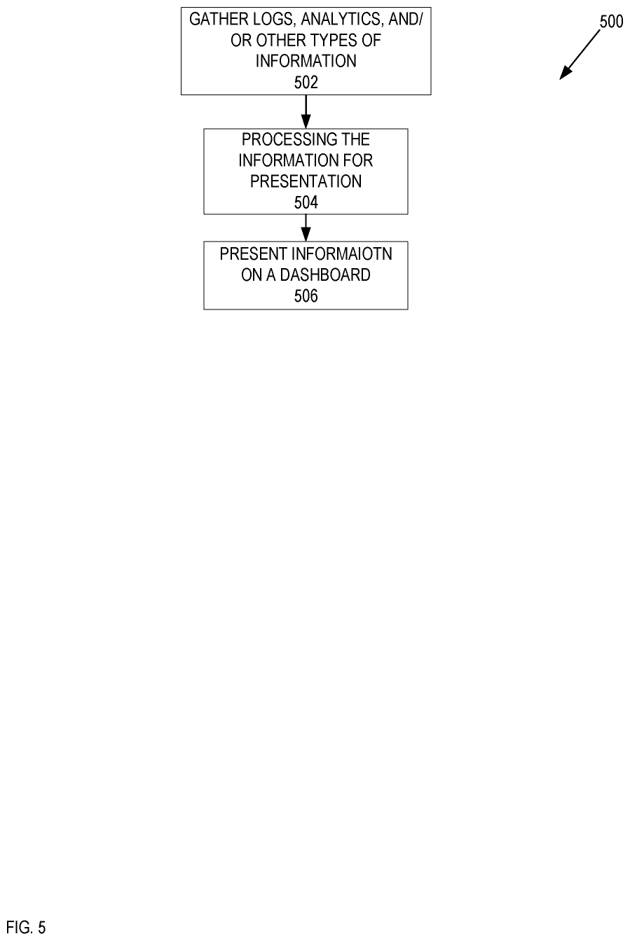

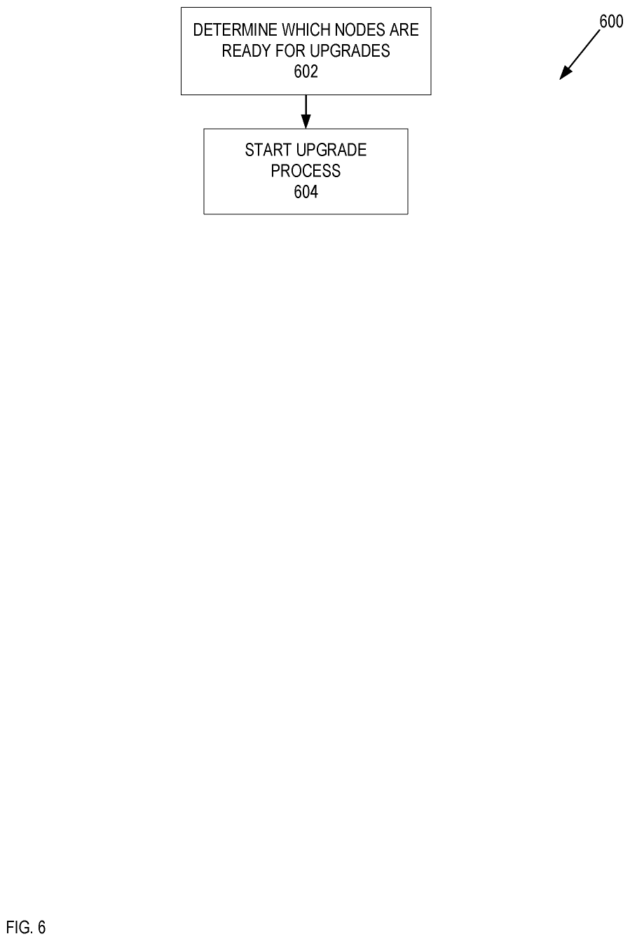

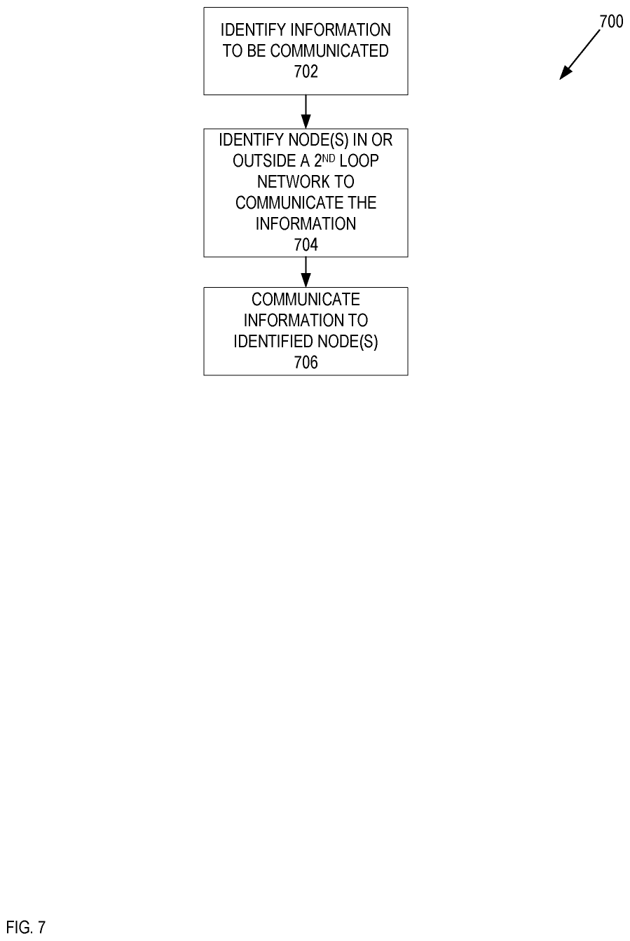

In a further embodiment, the master node 220 can monitor the loop network and the nodes of this network (e.g., monitoring the central aggregator and the worker nodes of this loop network). Monitoring the network and nodes is further described in FIG. 5 below. The master node can further perform maintenance for a loop network and the nodes of the network (e.g., performing software upgrades to the software used for the loop processes 208A-N of the work devices 202A-N and/or master node loop processes 218A-B of the central aggregators 210A-B). Network and node maintenance is further described in FIG. 6 below. In addition, the master node 220 can communicate information to the different nodes in a loop network. In this embodiment, federated learning users (e.g., users associated with the central aggregator) do not have access to information from the worker nodes in the loop network apart from the machine learning results, because the worker nodes are shielded from the public Internet and/or other types of networks. In addition, the master node 220 has access to unique identifiers for each of the worker nodes 202A-N and/or the central aggregating nodes 210A-B. The master node 220 can communicate information from the various loop network nodes to other nodes (e.g., push information, receive information, etc.). Communicating the information is further described in FIG. 7 below. In one embodiment, the master node 220 can exchange a central aggregating node identifier of the central aggregating node 210A-B with a worker identifier from the set of one or more worker nodes 202A-N. The master node can further configure a central aggregating node 210A-B and the set of one or more worker nodes 202A-N to communicate with each other using the central aggregating node and worker identifiers. In another embodiment, the master node 220 (or another node in the master node network) can act as a proxy for signed communications to occur between the central aggregating node 210A-B and the set of one or more worker nodes 202A-N. In one embodiment, the master node 220 includes a master node process 222 that performs the actions described above of the master node 220.

For example and in one embodiment, each of the worker nodes can be associated with a hospital that gathers a set of data from patients, test, trials, and/or other sources. This set of data can be used to train one or more models for use by pharmaceutical companies. This data, however, can be sensitive from a regulatory and/or economic perspective and the hospital would want a mechanism to keep this data private. The central aggregator can be associated with a pharmaceutical company, which would want to use one or more worker nodes to train a model. In this example, using a loop network created by the master node allows a pharmaceutical company to train a model while keeping the data of the worker node private.

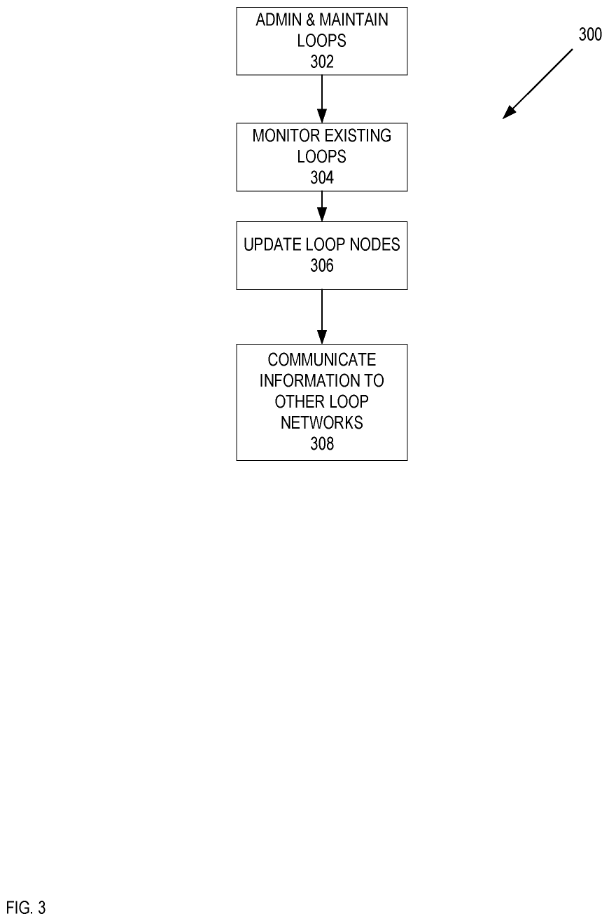

As described above, the master node administers the creation and maintenance of loop networks. FIG. 3 is a flow diagram of one embodiment of a process 300 to administer different federated learning network loops. In one embodiment, process 300 is performed by a master node process, such as the master node process 222 as described in FIG. 2 above. In FIG. 3, process 300 begins by administering and/or maintaining one or more loop networks at block 302. In one embodiment, process 300 creates a loop network by receiving a request to train a model from a central aggregator (or an entity associated with the central aggregator), posting the request in a portal, and handling requests from one or more worker nodes to handle the model training request. Administering and maintaining the one or more network loops is further described in FIG. 4 below.

At block 304, process 300 monitors the existing loop networks. In one embodiment, process 300 monitors the loop network and the nodes of this network (e.g., by monitoring the central aggregator and the worker nodes of this loop network). Monitoring the network and nodes is further described in FIG. 5 below. Process 300 updates the loop nodes at block 306. In one embodiment, process 300 performs maintenance for a loop network and the nodes of the network (e.g., by performing software upgrades to the software used for the loop processes of the worker nodes and/or the master node loop processes of the central aggregators). Network and node maintenance is further described in FIG. 6 below. At block 308, process 300 communicates information to other loop nodes. In this embodiment, federated learning users (e.g., users associated with the central aggregator) do not have access to information from the worker nodes in the loop network apart from the machine learning results, because the worker nodes are shielded from the public Internet. The master node can communicate information with the various loop network nodes to other nodes. Communicating the information is further described in FIG. 7 below.

As described above, the master node can create one or more loop networks by matching worker nodes with requesting central aggregators. FIG. 4 is a flow diagram of one embodiment of a process 400 to create a federated learning network loop. In one embodiment, process 400 is performed by a master node process, such as the master node process 222 as described in FIG. 2 above. In FIG. 4, process 400 begins by receiving information regarding central aggregator(s) at block 402. In one embodiment, the central aggregation information can be a request to train a model and other data to support that request. At block 404, process 400 posts the central aggregator request(s). In one embodiment, by posting these requests instead of having the central aggregator contact the worker nodes directly allows the worker nodes to maintain anonymity from this or other central aggregators. In one embodiment, process 400 posts the central aggregator requests on a portal that is accessible to various different worker nodes. For example and in one embodiment, this portal can contain a description of the current requests, including but not limited to the machine learning task, model type, data requirements, and training requirements.

Process 400 receives requests from worker nodes for the model training work from one of more central aggregator requests at block 406. In one embodiment, the model training can be a supervised machine learning training process that uses the training data from each of the worker nodes to train the model. In another embodiment, the model training can be a different type of model training. Process 400 matches the worker nodes to the central aggregator at block 408. In one embodiment, process 400 selects matching worker nodes by matching worker node characteristics with the requirements of the central aggregator request, including but not limited to, model type, data requirement and training requirements. Thus, each central aggregator will have a set of one or more worker nodes to use for training the model.

At block 410, process 400 sets up a loop network for each central aggregator and a corresponding set of worker nodes. In one embodiment, process 400 sends configuration commands to the central aggregator to configure the central aggregator to use the corresponding set of one or more worker nodes at its disposal for training of the model. In one embodiment, process 400 sends information that can include connection information and algorithm information. In this embodiment, the connection information can include one or more Internet Protocol (IP) addresses. Alternatively, the connection information can further include one or more pseudonym IP addresses, where a routing mechanism is used that would route network traffic through the master node, such that IP addresses are obfuscated and the master node can then use the pseudonym IP addresses to match to IP addresses. In a further alternative, virtual private network (VPN)-like methods can also be used to secure the connections. In one embodiment, the algorithm information can be the information to explain which algorithm should be run with which dataset and in which order (e.g., the compute plan). In addition, the process 400 sends configuration command(s) to each of the one or more worker nodes for this device. In one embodiment, process 400 can configure each of the worker nodes with the same or similar information used to configure the central aggregator. For example and in one embodiment, process 400 can send connection and algorithm information to each of the worker nodes. In this example, the same compute plan can be shared with the central aggregator and the worker nodes. With the central aggregator and the worker nodes configured, the loop network is created and the central aggregator can begin the process of using the worker nodes to train the model.

With the loop network created and the central aggregator managing the model training using the worker nodes, the master node can monitor the existing loop networks. FIG. 5 is a flow diagram of one embodiment of a process 500 to monitor existing federated learning loop networks. In one embodiment, process 500 is performed by a master node process, such as the master node process 222 as described in FIG. 2 above. In FIG. 5, process 500 begins by gathering logs, analytics, and/or other types of information being generated by the worker nodes and/or the central aggregator at block 502. In one embodiment, the type of information gathered by process 500 is information about the network traffic and the operations of the worker nodes and/or the central aggregator. In one embodiment, two types of information can be gathered: software execution information and error information. In this embodiment, the software execution information can include information that is related to how the software is performing. For example and in one embodiment, is the software performing appropriately or is the software stalling? In this example, this information may not be sensitive information. In another embodiment, the error information can include error logs from algorithms trained on data. This may be sensitive data since the errors may leak information about the data themselves. For any potential sensitive information, category and security processes can be organized around this type of information to protect the sensitivity. At block 504, process 500 processes the information for presentation. In one embodiment, the information is processed for presentation in a dashboard that allows a user to monitor the ongoing operations and the results of a model training. Process 500 presents the processed information on a dashboard at block 506. In one embodiment, the dashboard can present information for one or more model trainings managed by one or more central aggregators. In a further embodiment, the dashboard can be used by a user to monitor network traffic and node usage with the idea that this information can be used to identify and fix bottlenecks in the model training.

The master node can further be used to maintain the software used for loop networks on the worker nodes and/or the central aggregator. FIG. 6 is a flow diagram of one embodiment of a process 600 to update loop nodes. In one embodiment, process 600 is performed by a master node process, such as the master node process 222 as described in FIG. 2 above. In FIG. 6, process 600 begins by determining which nodes in a master node network are ready for software upgrades at block 602. In one embodiment, process 600 can trigger remote updates of the software on the nodes of the network (from within a closed network). In particular, process 600 can update the communication protocols and cryptographic primitives that are used for the functioning of the federated learning platform. Additionally, if the network involves consensus mechanisms, the master node can change these mechanisms. Furthermore, process 600 can also update nodes in a loop network as needed. With the identified nodes that are ready for a software upgrade, process 600 updates the identified nodes at block 604.

In one embodiment, users of a federated learning environment do not have access to information beyond the machine learning results (e.g., the result of the trained model), because users of the federated learning network will be shielded from the network used for the federated learning. In this embodiment, the master node can provide a flux of information from the master node to other nodes in order to display this exported information. For example and in one embodiment, this exported information could cover opportunities for a worker node to connect to other networks, information for maintenance, proposition for services, and/or other types of scenarios. In addition, and in one embodiment, the master node can communicate information to/from a device external to the master node network to a node within the master node network, where the information is channeled through the master node. In another embodiment, the master node can communicate information from a loop node to another loop node from another node network.

FIG. 7 is a flow diagram of one embodiment of a process 700 to communicate information to loop nodes. In one embodiment, process 700 is performed by a master node process, such as the master node process 222 as described in FIG. 2 above. In FIG. 7, process 700 begins by identifying information that is to be communicated by one set of nodes in one loop network or by an external device to another set of nodes at block 702. For example and in one embodiment, process 700 could identify information based on the arrival of new worker nodes, new datasets, new software releases, other types of information, information on external device(s), and/or a combination thereof. In another example, such information could include a model trained with a federated learning loop network. In a further example, the information can be used by an external device to remotely access a node in the master network. In another example, the information identified is a sketch of the training data stored in one or more of the worker nodes. In one embodiment, process 700 can perform an automated update of some or all nodes when a new dataset arrives. Alternatively, process 700 could receive information from another node (e.g., within a second loop network or an external device) and forward this information to a node in the original loop network. At block 704, process 700 identifies node(s) in or outside a second loop network that are to communicate the information. In one embodiment, the identified node can be within a loop network or can be a node that is external to that loop network. For example and in one embodiment, process 700 may want to export the existence of a worker node in one loop network to another loop network. Alternatively, process 700 may want to export information to a node that is an external device that is outside of a loop network. Process 700 communicates the information to the identified node(s) at block 706. In one embodiment, process 700 can communicate information from one loop network to another, where process 700 serves as a frontend to keep the nodes in a loop network with up-to-date with the platform state, and/or process 700 can push information to the local frontend that each node can run individually. In one embodiment, communication of information can include pushing information to another node, receiving information from another node, and/or forwarding information from one node to another.

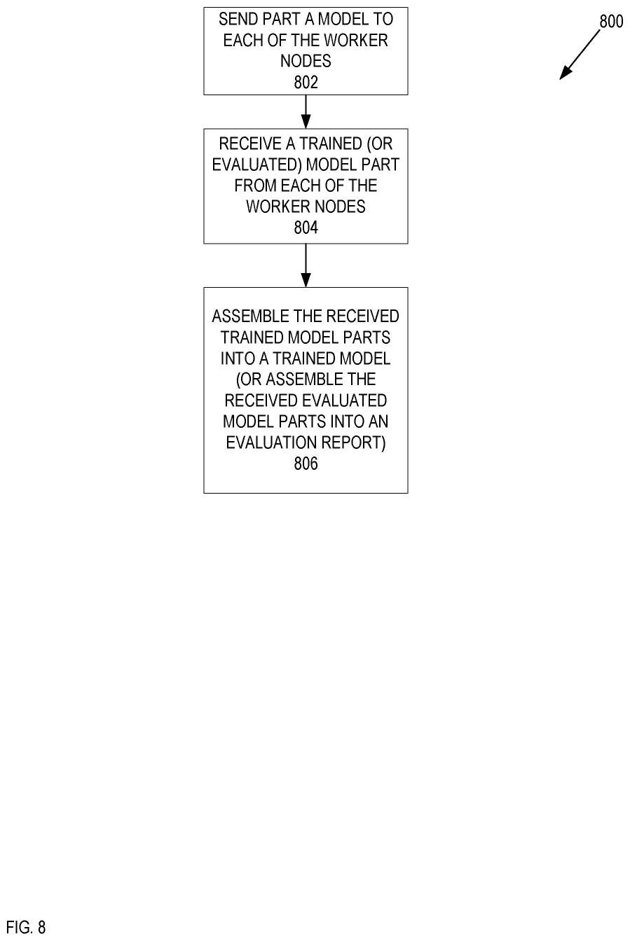

In one embodiment, with a loop network setup, the loop network can train a model using the worker nodes of the loop network. FIG. 8 is a flow diagram of one embodiment of a process 800 to train a model using the loop network. In one embodiment, a loop network is used to train the model, such as loop network 224A-B as illustrated in FIG. 2 above. In FIG. 8, process 800 begins by sending a part of a model to be trained to each of the worker nodes in the loop network at block 802. In one embodiment, each of the worker nodes in the loop network work on training their respective part of the model. In this embodiment, each worker node has its own training plan. In one embodiment, the training plan includes a configuration for how the training is to be conducted. In this embodiment, the training plan can include the algorithm for the model and/or include an object that defines the purpose of the computations. For example and in one embodiment, the object specifies a data format that the training data, an algorithm, and/or model should use, an identity of the test data points used to compare and evaluate the models and, metric calculation data which is used to quantify the accuracy of a model. If the object includes a request to evaluate a model, the object can further include an indication of the model to be evaluated and a metric used to evaluate that model, where each of the worker nodes used to evaluate the model include evaluation data that is used to evaluate the model. The training plan can also include an algorithm, which is a script that specifies the method to train a model using training data. In particular, the algorithm specifies the model type and architecture, the loss function, the optimizer, hyperparameters and, also identifies the parameters that are tuned during training.

At block 804, process 800 receives the trained model part from each of the worker nodes in the loop network. In one embodiment, each worker node sends back the trained model part to the central aggregator. In this embodiment, the training data each worker node is not revealed to the central aggregator as this training data remains private to the corresponding worker node. In another embodiment, if the object includes a request to evaluate a model, process 800 receives the evaluation parts from each of the worker nodes used for the evaluation process. Process 800 assembles the trained model and block 806. The trained model is forwarded to the original requestor of the trained model. In one embodiment, process 800 assembles (or aggregates) the trained model parts from each of the worker nodes in the set of one or more worker nodes in the central aggregator node. In this embodiment, the aggregation can be a secure aggregation, where the secure aggregation blocks access by the central aggregator node to the individual updated model parts. Alternatively, process 800 can assemble the received evaluation parts from the worker nodes used for the model evaluation process.

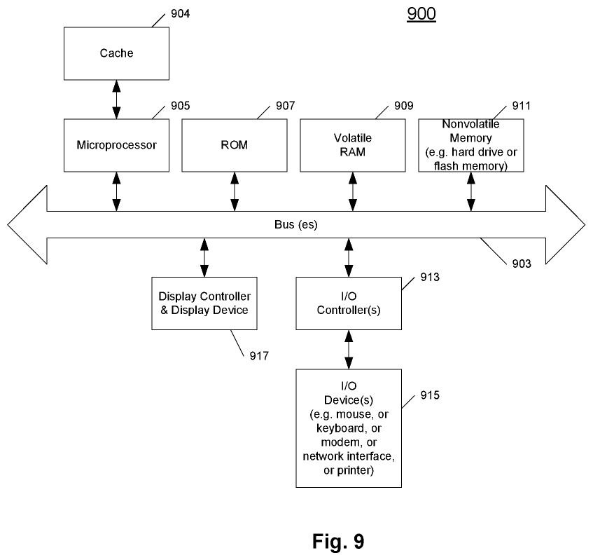

FIG. 9 shows one example of a data processing system 900, which may be used with one embodiment of the present invention. For example, the system 900 may be implemented including a master node 220 as shown in FIG. 2 above. Note that while FIG. 9 illustrates various components of a computer system, it is not intended to represent any particular architecture or manner of interconnecting the components as such details are not germane to the present invention. It will also be appreciated that network computers and other data processing systems or other consumer electronic devices, which have fewer components or perhaps more components, may also be used with the present invention.

As shown in FIG. 9, the computer system 900, which is a form of a data processing system, includes a bus 903 which is coupled to a microprocessor(s) 905 and a ROM (Read Only Memory) 907 and volatile RAM 909 and a non-volatile memory 911. The microprocessor 905 may include one or more CPU(s), GPU(s), a specialized processor, and/or a combination thereof. The microprocessor 905 may retrieve the instructions from the memories 907, 909, 911 and execute the instructions to perform operations described above. The bus 903 interconnects these various components together and also interconnects these components 905, 907, 909, and 911 to a display controller and display device 917 and to peripheral devices 915 such as input/output (I/O) devices which may be mice, keyboards, modems, network interfaces, printers and other devices which are well known in the art. Typically, the input/output devices 915 are coupled to the system through input/output controllers 913. The volatile RAM (Random Access Memory) 909 is typically implemented as dynamic RAM (DRAM), which requires power continually in order to refresh or maintain the data in the memory.

The mass storage 911 is typically a magnetic hard drive or a magnetic optical drive or an optical drive or a DVD RAM or a flash memory or other types of memory systems, which maintain data (e.g. large amounts of data) even after power is removed from the system. Typically, the mass storage 911 will also be a random access memory although this is not required. While FIG. 9 shows that the mass storage 911 is a local device coupled directly to the rest of the components in the data processing system, it will be appreciated that the present invention may utilize a non-volatile memory which is remote from the system, such as a network storage device which is coupled to the data processing system through a network interface such as a modem, an Ethernet interface or a wireless network. The bus 903 may include one or more buses connected to each other through various bridges, controllers and/or adapters as is well known in the art.

Portions of what was described above may be implemented with logic circuitry such as a dedicated logic circuit or with a microcontroller or other form of processing core that executes program code instructions. Thus processes taught by the discussion above may be performed with program code such as machine-executable instructions that cause a machine that executes these instructions to perform certain functions. In this context, a “machine” may be a machine that converts intermediate form (or “abstract”) instructions into processor specific instructions (e.g., an abstract execution environment such as a “virtual machine” (e.g., a Java Virtual Machine), an interpreter, a Common Language Runtime, a high-level language virtual machine, etc.), and/or, electronic circuitry disposed on a semiconductor chip (e.g., “logic circuitry” implemented with transistors) designed to execute instructions such as a general-purpose processor and/or a special-purpose processor. Processes taught by the discussion above may also be performed by (in the alternative to a machine or in combination with a machine) electronic circuitry designed to perform the processes (or a portion thereof) without the execution of program code.

The present invention also relates to an apparatus for performing the operations described herein. This apparatus may be specially constructed for the required purpose, or it may comprise a general-purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), RAMs, EPROMs, EEPROMs, magnetic or optical cards, or any type of media suitable for storing electronic instructions, and each coupled to a computer system bus.

A machine readable medium includes any mechanism for storing or transmitting information in a form readable by a machine (e.g., a computer). For example, a machine readable medium includes read only memory (“ROM”); random access memory (“RAM”); magnetic disk storage media; optical storage media; flash memory devices; etc.

An article of manufacture may be used to store program code. An article of manufacture that stores program code may be embodied as, but is not limited to, one or more memories (e.g., one or more flash memories, random access memories (static, dynamic or other)), optical disks, CD-ROMs, DVD ROMs, EPROMs, EEPROMs, magnetic or optical cards or other type of machine-readable media suitable for storing electronic instructions. Program code may also be downloaded from a remote computer (e.g., a server) to a requesting computer (e.g., a client) by way of data signals embodied in a propagation medium (e.g., via a communication link (e.g., a network connection)).

The preceding detailed descriptions are presented in terms of algorithms and symbolic representations of operations on data bits within a computer memory. These algorithmic descriptions and representations are the tools used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “posting,” “creating,” “receiving,” “computing,” “exchanging,” “processing,” “configuring,” “augmenting,” “sending,” “assembling,” “monitoring,” “gathering,” “updating,” “pushing,” “aggregating,” “broadcasting,” “communicating,” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The processes and displays presented herein are not inherently related to any particular computer or other apparatus. Various general-purpose systems may be used with programs in accordance with the teachings herein, or it may prove convenient to construct a more specialized apparatus to perform the operations described. The required structure for a variety of these systems will be evident from the description below. In addition, the present invention is not described with reference to any particular programming language. It will be appreciated that a variety of programming languages may be used to implement the teachings of the invention as described herein.

The foregoing discussion merely describes some exemplary embodiments of the present invention. One skilled in the art will readily recognize from such discussion, the accompanying drawings and the claims that various modifications can be made without departing from the spirit and scope of the invention.

1. A method of creating a loop network that trains a model, the method comprising:
creating a loop network between a central aggregating node and a set of one or more worker nodes, wherein the loop network communicatively couples the central aggregating node and the set of one or more worker nodes.
receiving and broadcasting a model training request from one of the nodes in the loop network to one or more other nodes in the loop network.

2. The method of claim 1, wherein the creation of the loop network is performed using a master node network and the master node network includes a set of one or more non-master nodes and a master node.

3-6. (canceled)

7. The method of claim 52, wherein each loop network is not visible with other loop networks.

8-9. (canceled)

10. The method of claim 32, further comprising
exchanging a central aggregating node identifier of the central aggregating node with a worker identifier from the set of one or more worker nodes; and
configuring the central aggregating node and the set of one or more worker nodes to communicate with each other using the central aggregating node and worker identifiers.

11. The method of claim 3, wherein a node from the master node network is selected to act as a proxy for signed communications to occur between the central aggregating node and the set of one or more worker nodes.

12. (canceled)

13. The method of claim 1, wherein the central aggregator nodes and the worker nodes belonging to the loop network perform a training of the model.

14. The method of claim 13, wherein the training comprises:
sending part of the model from the central aggregator node to each of the worker nodes in the set of one or more worker nodes, wherein each of the worker nodes update that part of the model;
aggregating the updated model parts from each of the worker nodes in the set of one or more worker nodes in the central aggregator node; and
updating the current model with the aggregated updated model parts into a new current model.

15. The method of claim 14, wherein the aggregation of the updated model parts from each of the worker nodes comprises:
performing a secure aggregation.

16-18. (canceled)

19. The method of claim 1, further comprising:
monitoring the master node network.

20. The method of claim 19, wherein the monitoring of the master nodes network comprises:
gathering information from the central aggregating nodes and the set of one or more worker nodes; and
processing the gathered information for presentation.

21-24. (canceled)

25. The method of claim 1, further comprising:
pushing information from one node inside the master node network to an external device through the master node, and
pushing information from an external device to one node inside the master node network through the master node.

26. The method of claim 25, wherein the information exchanged can be used to enable a remote access to said node in the master node network from the external device.

27. The method of claim 26, wherein information exchanged comprises sketches of the training data stored in the said nodes.

28. A method of creating a loop network that evaluates a model, the method comprising:
creating a loop network between a central aggregating node and a set of one or more worker nodes, wherein the loop network communicatively couples the central aggregating node and the set of one or more worker nodes.
receiving and broadcasting a model evaluation request for the model from the central aggregating node to one or more worker nodes.

29. The method of claim 28, wherein the central aggregating node has a model to be evaluated and a metric to evaluate it.

30. The method of claim 28, wherein each worker node in the set of one or more worker nodes includes evaluation data that is used to evaluate the model within the loop network.

31. The method of claim 28, wherein model evaluation comprises:
sending the model and an evaluation metric from the central aggregating node to the worker nodes;
evaluating the model on each worker node with the evaluation data and the evaluation metric;
sending evaluation metric results from each worker node to the central aggregating node.

32. A non-transitory machine readable medium according having executable instructions to cause one or more processing units to perform a method of creating a loop network that trains a model, the method comprising:
creating a loop network between a central aggregating node and a set of one or more worker nodes, wherein the loop network communicatively couples the central aggregating node and the set of one or more worker nodes.
receiving and broadcasting a model training request from one of the nodes in the loop network to one or more other nodes in the loop network.

33-58. (canceled)

59. A non-transitory machine readable medium according having executable instructions to cause one or more processing units to perform a method of creating a loop network that evaluates a model, the method comprising:
creating a loop network between a central aggregating node and a set of one or more worker nodes, wherein the loop network communicatively couples the central aggregating node and the set of one or more worker nodes.
receiving and broadcasting a model evaluation request for the model from the central aggregating node to one or more worker nodes.

60-62. (canceled)
